(19) United States
(12) Patent Application Publication
(10) Pub. No.: US 2024/0205248 A1
(43) Pub. Date: Jun. 20, 2024

(54) MONITORING TOOL FOR DETECTING VIOLATIONS OF DEVICE BEHAVIOR CONSTRAINTS

(71) Applicant: Dell Products L.P., Round Rock, TX (US)

(72) Inventors: Yevgeni Gehtman, Modi'in (IL); Tomer Shachar, Beer-Sheva (IL); Maxim Balin, Gan-Yavne (IL)

(21) Appl. No.: 18/081,762

(22) Filed: Dec. 15, 2022

(51) Int. Cl. H04L 9/40

(52) U.S. Cl. CPC H04L 63/1425; H04L 63/102; H04L 63/1416

(57) ABSTRACT

Techniques are provided for device protection using device behavior monitoring. One method comprises obtaining a device behavior constraint that limits behavior of a device; monitoring an action performed by the device; determining if the monitored action of the device violates the processor-readable device behavior constraint; and initiating an automated action in response to a result of the determining. A user of the device may be an authenticated user and the monitoring may detect anomalous behavior of the authenticated user and/or the device. The processor-readable device behavior constraint may limit one or more of: internal communications within the device; external communications between the device and another device; one or more external devices that may connect to the device; and communications of a designated communication type. The device behavior constraint may enforce: a policy of an organization; a designated device configuration; an expected device behavior and a device behavior rule.

### FIELD

The field relates generally to information processing systems, and more particularly to the protection of such information processing systems.

### BACKGROUND

Computing devices are typically configured to incorporate security functionality to protect such devices from malicious activity. For example, it may be desirable to prevent suspicious computer operations unless they are implemented by a legitimate and authorized user. Role-based access control (RBAC) techniques may be employed to restrict access to devices or network resources based on the roles of individual users within an organization. RBAC techniques typically allow users to access only the information and other resources needed for their jobs and prevent users from accessing additional resources. RBAC techniques, however, are vulnerable to various types of attacks, such as password theft and/or session hijacking.

A need exists for improved techniques for protecting devices from suspicious and/or unauthorized computer operations or other device actions.

### SUMMARY

In one embodiment, a method comprises obtaining at least one processor-readable device behavior constraint that limits one or more behaviors of at least one processing device; monitoring at least one action performed by the at least one processing device; determining if the at least one monitored action of the at least one processing device violates the at least one processor-readable device behavior constraint; and initiating at least one automated action in response to a result of the determining.

In some embodiments, a user of the at least one processing device is an authenticated user and the monitoring detects anomalous behavior of one or more of the authenticated user and the at least one processing device. The monitoring may be performed in response to a successful authentication of the user of the at least one processing device. The at least one processor-readable device behavior constraint may comprise a constraint that limits one or more of: internal communications within the at least one processing device; external communications between the at least one processing device and at least one other device; one or more external devices that connect to the at least one processing device; and one or more communications of a designated type. The at least one processor-readable device behavior constraint may enforce one or more of: at least one policy of an organization; at least one designated device configuration; at least one expected device behavior and at least one processing device behavior rule.

In one or more embodiments, the monitoring is performed by at least one software entity associated with an operating system of the at least one processing device. The monitoring may comprise the at least one software entity associated with the operating system of the at least one processing device intercepting one or more requests to execute one or more device operations.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for device behavior monitoring in accordance with an illustrative embodiment;

FIG. 2 is a sample table illustrating exemplary device behavior constraint policies in accordance with an illustrative embodiment;

FIG. 3 is a flow chart illustrating an exemplary implementation of a process for device behavior monitoring in accordance with an illustrative embodiment;

FIG. 4 is a flow chart illustrating an exemplary implementation of a process for device protection using device behavior monitoring in accordance with an illustrative embodiment;

FIG. 5 illustrates an exemplary processing platform that may be used to implement at least a portion of one or more embodiments of the disclosure comprising a cloud infrastructure; and

FIG. 6 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for device protection using device behavior monitoring.

In one or more embodiments, the disclosed device behavior monitoring techniques continue to monitor behavior of a given device, even after the user of the given device has successfully passed a multi-factor authentication, for example. Violations of specified device behavior constraints may occur, for example, in the event of a security breach (e.g., following an effort to repeatedly try different login credentials, a successful phishing attempt to obtain legitimate login credentials or a misappropriated mobile telephone of a user, for example, as a valid second factor of a multi-factor authentication). One or more aspects of the disclosure recognize that even when a potential attacker has successfully passed a multi-factor authentication, the potential attacker may not know how to act in accordance with specified device behavior constraints. In this manner, an ongoing validation of a successful multi-factor authentication is provided by observing device behavior relative to defined device behavior constraints.

Among other benefits, the disclosed techniques for device protection using device behavior monitoring can detect and mitigate unauthorized and/or malicious operations, such as attempts to: (i) perform an unauthorized encryption or deletion of one or more files; (ii) execute sensitive operations (or other designated operations) that may impair the operation of the device or the data of the device and/or (iii) suspend operation of a device.

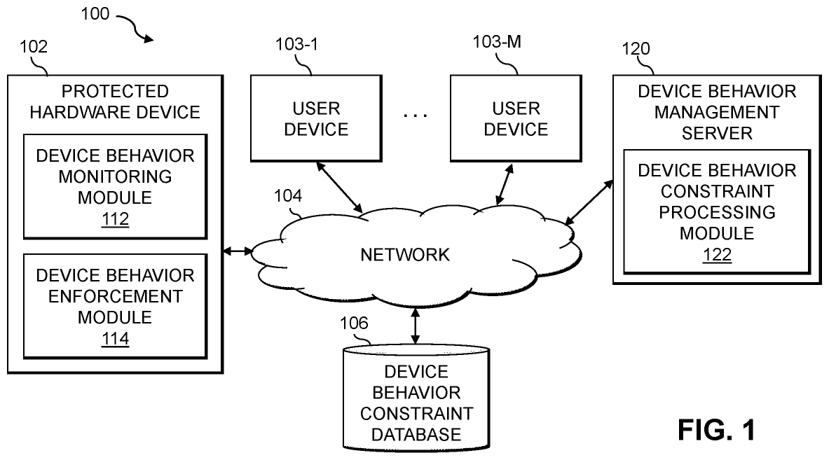

FIG. 1 shows a computer network (also referred to herein as an information processing system) 100 configured in accordance with an illustrative embodiment. The computer network 100 comprises a plurality of user devices 103-1 through 103-M, collectively referred to herein as user devices 103. The user devices 103 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is one or more protected hardware devices 102, one or more device behavior management servers 120 and one or more device behavior constraint databases 106, discussed below.

The protected hardware devices 102 may comprise edge devices, host devices and other devices. One or more aspects of the disclosure recognize that edge devices, for example, are attractive targets for an attack and often comprise critical infrastructure that may require special monitoring. Edge devices may be stored, for example, in a physical location that may not be properly secured. An attacker may be able to access a perimeter of a location of the edge device (or another adjacent or nearby location that is within range of the edge device).

The user devices 103 may comprise, for example, host devices and/or devices such as mobile telephones, laptop computers, tablet computers, desktop computers or other types of computing devices. Such devices are examples of what are more generally referred to herein as “processing devices” which may be protected using the disclosed device protection techniques. Some of these processing devices are also generally referred to herein as “computers.” The user devices 103 may comprise a network client that includes networking capabilities such as ethernet, Wi-Fi, etc. When the user devices 103 are implemented as host devices, the host devices may illustratively comprise servers or other types of computers of an enterprise computer system, cloud-based computer system or other arrangement of multiple compute nodes associated with respective users.

For example, the host devices in some embodiments illustratively provide compute services such as execution of one or more applications on behalf of each of one or more users associated with respective ones of the host devices.

The user devices 103 in some embodiments comprise respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

It is to be appreciated that the term “user” in this context and elsewhere herein is intended to be broadly construed so as to encompass, for example, human, hardware, software or firmware entities (including services), as well as various combinations of such entities. Compute and/or storage services may be provided for users under a Platform-as-a-Service (PaaS) model, a Storage-as-a-Service (STaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

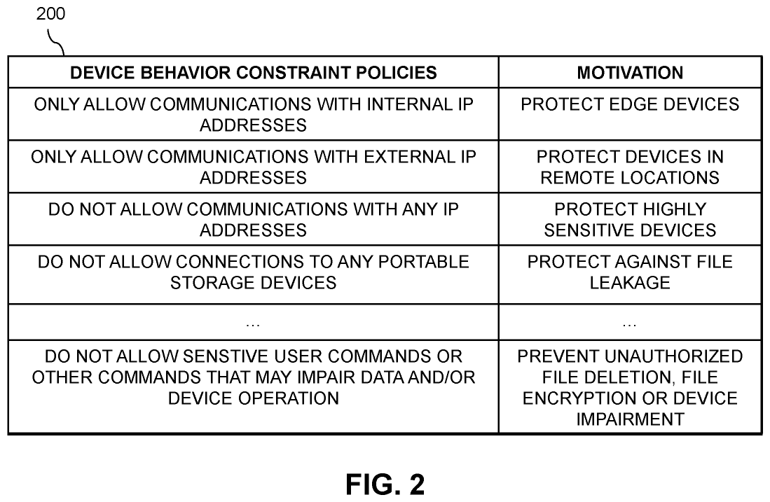

As shown in FIG. 1, an exemplary protected hardware device 102 may comprise a device behavior monitoring module 112 and a device behavior enforcement module 114. In some embodiments, the device behavior monitoring module 112 automatically monitors actions being performed by the respective protected hardware device 102 for violations of specified device behavior constraints, as discussed further below in conjunction with FIGS. 2 through 4. The device behavior enforcement module 114 automatically performs one or more specified actions, such as mitigation actions, in response to a detected violation of a device behavior constraint, as discussed further below in conjunction with FIGS. 2 through 4. In addition, the device behavior enforcement module 114 may interact with a device behavior constraint processing module 122, discussed further below, for example, of the device behavior management server 120 to receive and implement device behavior constraints.

It is to be appreciated that this particular arrangement of modules 112, 114 illustrated in the protected hardware device 102 of the FIG. 1 embodiment is presented by way of example only, and alternative arrangements can be used in other embodiments. For example, the functionality associated with modules 112, 114 in other embodiments can be combined into a single element, or separated across a larger number of elements. As another example, multiple distinct processors can be used to implement different ones of modules 112 and 114 or portions thereof.

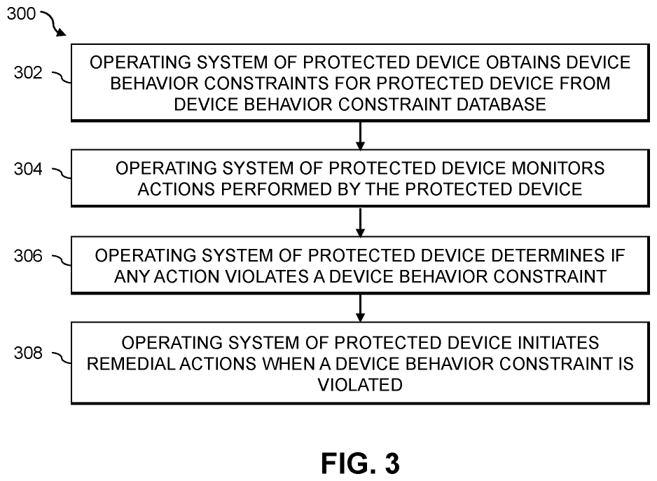

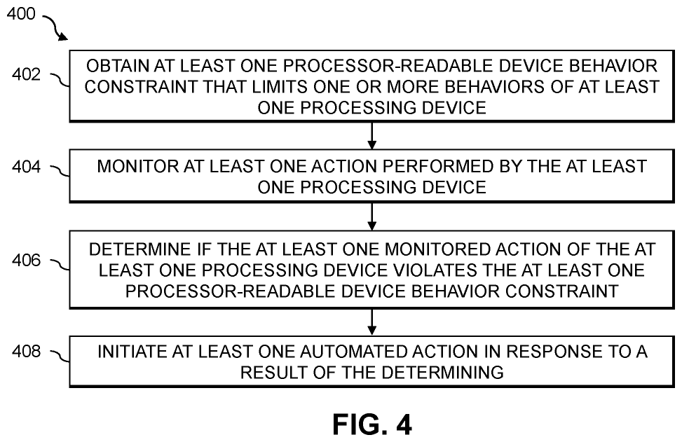

At least portions of modules 112, 114 may be implemented at least in part in the form of software that is stored in memory and executed by a processor. An exemplary process utilizing modules 112, 114 of the protected hardware device 102 in computer network 100 will be described in more detail with reference to FIGS. 3 and 4.

Other protected hardware devices 102 (not shown in FIG. 1) are assumed to be configured in a manner similar to that shown for protected hardware device 102 in the figure.

The device behavior management server 120 may be implemented, for example, on the cloud, such as a private cloud, or on the premises of an enterprise or another entity, as discussed further below. In some embodiments, the device behavior management server 120, or portions thereof, may be implemented as part of a host device. The device behavior management server 120 may manage and update the device behavior constraints, for example, consistent with the policies of a given organization and/or the expected behavior of one or more protected hardware devices 102. As also depicted in FIG. 1, the device behavior management server 120 further comprises a device behavior constraint processing module 122. In some embodiments, the device behavior constraint processing module 122 performs a multi-factor authentication of one or more users and interacts with, for example, the device behavior enforcement module 114 of one or more protected hardware devices 102 to provide new and/or updated device behavior constraints to be monitored by the device behavior enforcement module 114 of a respective protected hardware device 102. In other embodiments, one or more of the protected hardware devices 102 may include the device behavior constraint processing module 122 instead of, or in addition, to the device behavior management server 120 (e.g., to self-manage the device behavior constraint information).

It is to be appreciated that this particular arrangement of the device behavior constraint processing module 122 illustrated in the device behavior management server 120 of the FIG. 1 embodiment is presented by way of example only, and alternative arrangements can be used in other embodiments. For example, the functionality associated with device behavior constraint processing module 122 in other embodiments can include additional modules, or be separated across a larger number of modules. As another example, multiple distinct processors can be used to implement different portions of device behavior constraint processing module 122.

At least portions of device behavior constraint processing module 122 may be implemented at least in part in the form of software that is stored in memory and executed by a processor. An exemplary process utilizing device behavior constraint processing module 122 of an example device behavior management server 120 in computer network 100 will be described in more detail with reference to the flow diagrams of, for example, FIGS. 3 and 4.

Additionally, the protected hardware device 102 and/or the device behavior management server 120 can have an associated device behavior constraint database 106 configured to store, for example, a set of device behavior constraint policies, device-specific behavior expected profiles and/or information related to various devices, such as one or more protected hardware devices 102, such as device locations, network address assignments and performance data. The device behavior constraint database 106 may be maintained, for example, by the device behavior management server 120.

At least portions of the device behavior constraint database 106 configured to store the device behavior constraints may be implemented, for example, using a vault or another protected storage provided by an operating system of one or more of the protected hardware devices 102, user devices 103 and/or device behavior management servers 120. In some embodiments, any changes to data stored in the protected storage requires a designated level of approval.

The device behavior constraint database 106 in the present embodiment is implemented using one or more storage systems associated with the device behavior management server 120. Such storage systems can comprise any of a variety of different types of storage such as, network-attached storage (NAS), storage area networks (SANs), direct-attached storage (DAS) and distributed DAS, as well as combinations of these and other storage types, including software-defined storage.

The one or more protected hardware devices 102, user devices 103 and/or device behavior management servers 120 may be implemented on a common processing platform, or on separate processing platforms. The one or more protected hardware devices 102 and user devices 103 may be configured to interact over the network 104 in at least some embodiments with the device behavior management server 120.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the user devices 103 and the storage system to reside in different data centers. Numerous other distributed implementations of the host devices and the storage system are possible.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the one or more protected hardware devices 102, user devices 103 and/or device behavior management servers 120 can be one or more input-output devices (not shown), which illustratively comprise keyboards, displays or other types of input-output devices in any combination. Such input-output devices can be used, for example, to support one or more user interfaces to the device behavior management server 120, as well as to support communication between the device behavior management server 120 and other related systems and devices not explicitly shown.

The one or more protected hardware devices 102, user devices 103 and/or device behavior management servers 120 in the FIG. 1 embodiment are assumed to be implemented using at least one processing device. Each such processing device generally comprises at least one processor and an associated memory, and implements one or more functional modules for controlling certain features of the respective device.

More particularly, the one or more protected hardware devices 102, user devices 103 and/or device behavior management servers 120 in this embodiment each can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including SSDs, and should therefore not be viewed as limited in any way to spinning magnetic media.

The network interface allows the one or more protected hardware devices 102, user devices 103 and/or device behavior management servers 120 to communicate in some embodiments over the network 104 with each other (as well as one or more other networked devices), and illustratively comprises one or more conventional transceivers.

It is to be understood that the particular set of elements shown in FIG. 1 for device protection using device behavior monitoring is presented by way of illustrative example only, and in other embodiments additional or alternative elements may be used. Thus, another embodiment includes additional or alternative systems, devices and other network entities, as well as different arrangements of modules and other components.

FIG. 2 is a sample table 200 illustrating exemplary device behavior constraint policies in accordance with some embodiments. The disclosed techniques for detecting violations of device behavior constraints can be employed to enforce any desired device behavior constraints, as would be apparent to a person of ordinary skill in the art. The device behavior constraint policies may comprise device-specific constraints based, for example, on characteristics of a device installation (e.g., expected behavior based on what the expected usage of the device). In addition, one or more of the device behavior constraint policies may by specific to the devices of a given organization based, for example, on organizational policies and/or best practices.

In the example of FIG. 2, the exemplary device behavior constraint policies in table 200 comprise a policy specifying that only communications with internal IP addresses are allowed (for example, to protect edge devices where only internal communications are expected). In addition, a further policy may specify that only communications with external IP addresses are allowed (for example, to protect devices installed in remote locations where only external communications are expected). Another device behavior constraint policy may specify that no IP communications are allowed (for example, to protect highly-sensitive devices by preventing any communications).

In some embodiments, a device behavior constraint policy may be specified to prevent a given device from connecting to any portable storage devices, for example, such as memory sticks and other USB devices. In this manner, an organization can prevent file leakage (for example, by a rogue employee attempting to copy files and/or other data of the organization). In addition, a device behavior constraint policy may be specified to prevent sensitive commands (or other designated commands) that may impair a given device and/or the files (or other data) associated with the given device. In this manner, unauthorized and/or malicious operations can be detected and mitigated, such as attempts to: (i) perform an unauthorized encryption or deletion of one or more files; (ii) execute sensitive operations (or other designated operations) that may impair the operation of the device or the data of the device and/or (iii) suspend operation of a device.

In some embodiments, the designated commands that are prevented by one or more device behavior constraints may comprise sensitive commands or other commands of a designated command type. Such sensitive commands may be identified, for example, by evaluating one or more of: one or more sensitive commands identified, for example, in the device behavior constraint database 106; one or more sensitive command properties identified, for example, in the device behavior constraint database 106 and one or more sensitive command criteria identified, for example, in the device behavior constraint database 106.

Such sensitive commands may comprise, for example, one or more of the following commands: a user add command to create one or more users; a command to change a password for one or more user accounts; a change mode command that changes an access mode of a file; a super user command that allows a permitted user, sometimes referred to as a super user, to execute a command on behalf of another user, as specified, for example, by a security policy; a super user command used to run a function as a different user; a yum command that allows users and system administrators to install, update, remove and/or search software packages on a system; an apt command for installing, updating, removing, and/or otherwise managing deb packages on Ubuntu, Debian, and related Linux distributions; a zipper command to specify a compression level; a user modification command to modify one or more existing user account details, such as a username, a password, a home directory location, and/or a default shell; a system control command for examining and controlling, for example, the service manager; and/or a system command to pass commands to the operating system.

FIG. 3 is a flow chart illustrating an exemplary implementation of a process 300 for device behavior monitoring in accordance with an illustrative embodiment. In the example of FIG. 3, the operating system of a protected device obtains device behavior constraints for the protected device in step 302, for example, from the device behavior constraint database 106. In step 304, the operating system of the protected device monitors the actions performed by the protected device. In step 306, the operating system of protected device determines if any monitored action violates one of the device behavior constraints. For example, a device behavior constraint may specify that only communications with external IP addresses are allowed (for example, to protect devices installed in remote locations where only external communications are expected), and the process 300 may detect a communication with an internal IP address.

In step 308, the operating system of the protected device initiates one or more remedial actions when a device behavior constraint is violated. For example, the operating system may generate an alert, deny one or more network connections of the at least one device; prevent a performance of one or more additional actions of the at least one device; prevent communications on one or more ports of the at least one device; and/or deactivate at least a portion of the at least one device.

FIG. 4 is a flow chart illustrating an exemplary implementation of a process 400 for device protection using device behavior monitoring, according to one embodiment of the disclosure. In the example of FIG. 4, the process 400 obtains at least one processor-readable device behavior constraint in step 402 that limits one or more behaviors of at least one processing device. In step 404, at least one action performed by the at least one processing device is monitored. In step 406, the process 400 determines if the at least one monitored action of the at least one processing device violates the at least one processor-readable device behavior constraint. In step 408, the process 400 initiates at least one automated action in response to a result of the determining.

In some embodiments, a user of the at least one processing device is an authenticated user and the monitoring detects anomalous behavior of the authenticated user and/or the at least one processing device. The monitoring may be performed in response to a successful authentication of the user of the at least one processing device. The at least one processor-readable device behavior constraint may comprise a constraint that limits one or more of: internal communications within the at least one processing device; external communications between the at least one processing device and at least one other device; one or more external devices that connect to the at least one processing device; and one or more communications of a designated type. The at least one processor-readable device behavior constraint may enforce one or more of: at least one policy of an organization; at least one designated device configuration; at least one expected device behavior and at least one processing device behavior rule.

In one or more embodiments, the monitoring is performed by at least one software entity associated with an operating system of the at least one processing device. The monitoring may comprise the at least one software entity associated with the operating system of the at least one processing device intercepting one or more requests to execute one or more device operations. For additional details regarding interception of device operations by one or more software entities associated with an operating system, see, for example, U.S. patent application Ser. No. 17/958,844, filed Oct. 3, 2022, entitled “Device Protection Using Pre-Execution Command Interception and Evaluation,” incorporated by reference herein in its entirety.

In at least one embodiment, the at least one automated action comprises one or more of: generating an alert, denying one or more network connections of the at least one processing device; preventing a performance of one or more actions of the at least one processing device; preventing communications on one or more ports of the at least one processing device; and deactivating at least a portion of the at least one processing device.

The particular processing operations and other network functionality described in conjunction with FIGS. 3 and 4, for example, are presented by way of illustrative example only, and should not be construed as limiting the scope of the disclosure in any way. Alternative embodiments can use other types of processing operations for device protection using device behavior monitoring. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

The disclosed techniques for device protection using device behavior monitoring can be employed, for example, to monitor for unauthorized command execution (or other device actions) and to mitigate a detected unauthorized device action by automatically performing one or more actions to prevent an execution of the unauthorized action and/or to mitigate an impact of any unauthorized actions.

One or more embodiments of the disclosure provide improved methods, apparatus and computer program products for device protection using device behavior monitoring. The foregoing applications and associated embodiments should be considered as illustrative only, and numerous other embodiments can be configured using the techniques disclosed herein, in a wide variety of different applications.

It should also be understood that the disclosed device behavior monitoring techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for device protection using device behavior monitoring may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based device behavior monitoring engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based device behavior monitoring platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

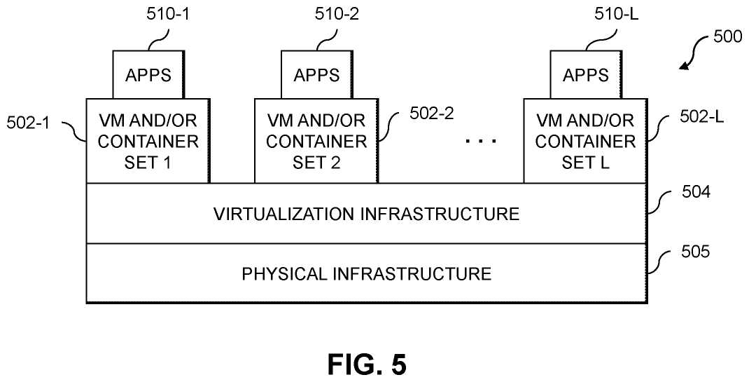

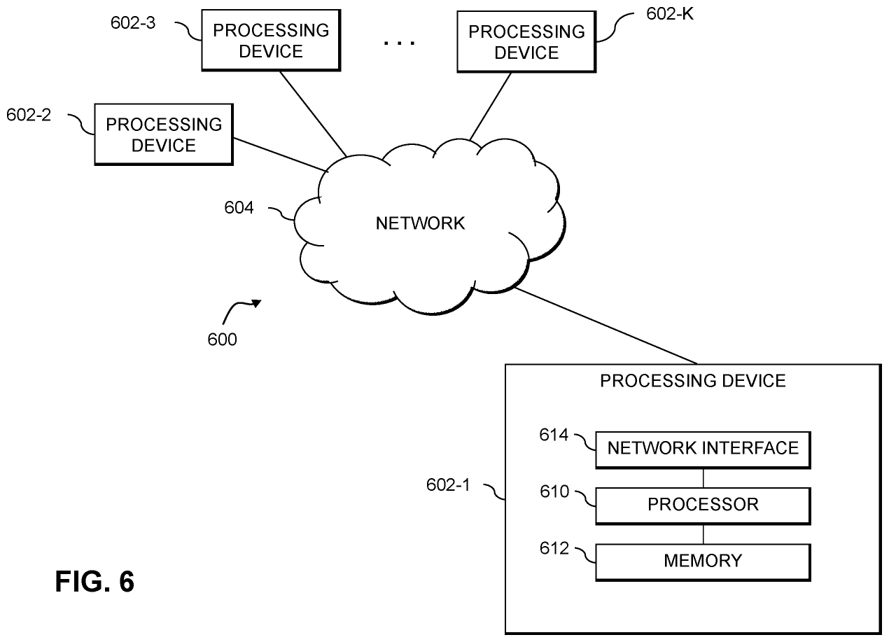

Illustrative embodiments of processing platforms will now be described in greater detail with reference to FIGS. 5 and 6. These platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. Such implementations can provide unauthorized device behavior detection functionality of the type described above for one or more processes running on a given one of the VMs. For example, each of the VMs can implement unauthorized device behavior detection control logic and associated mitigation functionality for one or more processes running on that particular VM.

An example of a hypervisor platform that may be used to implement a hypervisor within the virtualization infrastructure 504 is the VMware® vSphere® which may have an associated virtual infrastructure management system such as the VMware® vCenter™. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such implementations can provide unauthorized device behavior detection and mitigation functionality of the type described above for one or more processes running on different ones of the containers. For example, a container host device supporting multiple containers of one or more container sets can implement one or more instances of unauthorized device behavior detection control logic and associated mitigation functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises at least a portion of the given system and includes a plurality of processing devices, denoted 602-1, 602-2, 602-3, . . . 602-K, which communicate with one another over a network 604. The network 604 may comprise any type of network, such as a WAN, a LAN, a satellite network, a telephone or cable network, a cellular network, a wireless network such as WiFi or WiMAX, or various portions or combinations of these and other types of networks.

The processing device 602-1 in the processing platform 600 comprises a processor 610 coupled to a memory 612. The processor 610 may comprise a microprocessor, a microcontroller, an ASIC, an FPGA or other type of processing circuitry, as well as portions or combinations of such circuitry elements, and the memory 612, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 5 or 6, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one processor-readable device behavior constraint that limits one or more behaviors of at least one processing device;
monitoring at least one action performed by the at least one processing device;
determining if the at least one monitored action of the at least one processing device violates the at least one processor-readable device behavior constraint; and
initiating at least one automated action in response to a result of the determining;
wherein the method is performed by the at least one processing device, wherein the at least one processing device comprises a processor coupled to a memory.

2. The method of claim 1, wherein a user of the at least one processing device is an authenticated user and wherein the monitoring detects anomalous behavior of one or more of the authenticated user and the at least one processing device.

3. The method of claim 1, wherein the monitoring is performed in response to a successful authentication of a user of the at least one processing device.

4. The method of claim 1, wherein the at least one processor-readable device behavior constraint comprises a constraint that limits one or more of: internal communications within the at least one processing device; external communications between the at least one processing device and at least one other device; one or more external devices that connect to the at least one processing device; and one or more communications of a designated type.

5. The method of claim 1, wherein the at least one processor-readable device behavior constraint enforces one or more of: at least one policy of an organization; at least one designated device configuration; at least one expected device behavior and at least one processing device behavior rule.

6. The method of claim 1, wherein the monitoring is performed by at least one software entity associated with an operating system of the at least one processing device.

7. The method of claim 6, wherein the monitoring comprises the at least one software entity associated with the operating system of the at least one processing device intercepting one or more requests to execute one or more device operations.

8. The method of claim 1, wherein the at least one automated action comprises one or more of: generating an alert, denying one or more network connections of the at least one processing device; preventing a performance of one or more actions of the at least one processing device; preventing communications on one or more ports of the at least one processing device; and deactivating at least a portion of the at least one processing device.

9. An apparatus comprising:
at least one processing given device comprising a processor coupled to a memory;
the at least one processing given device being configured to implement the following steps:
obtaining at least one processor-readable device behavior constraint that limits one or more behaviors of the at least one processing device;
monitoring at least one action performed by the at least one processing device;
determining if the at least one monitored action of the at least one processing device violates the at least one processor-readable device behavior constraint; and
initiating at least one automated action in response to a result of the determining.

10. The apparatus of claim 9, wherein the monitoring is performed in response to a successful authentication of a user of the at least one processing device.

11. The apparatus of claim 9, wherein the at least one processor-readable device behavior constraint comprises a constraint that limits one or more of: internal communications within the at least one processing device; external communications between the at least one processing device and at least one other device; one or more external devices that connect to the at least one processing device; and one or more communications of a designated type.

12. The apparatus of claim 9, wherein the at least one processor-readable device behavior constraint enforces one or more of: at least one policy of an organization; at least one designated device configuration; at least one expected device behavior and at least one processing device behavior rule.

13. The apparatus of claim 9, wherein the monitoring is performed by at least one software entity associated with an operating system of the at least one processing device, and wherein the monitoring comprises the at least one software entity associated with the operating system of the at least one processing device intercepting one or more requests to execute one or more device operations.

14. The apparatus of claim 9, wherein the at least one automated action comprises one or more of: generating an alert, denying one or more network connections of the at least one processing device; preventing a performance of one or more actions of the at least one processing device; preventing communications on one or more ports of the at least one processing device; and deactivating at least a portion of the at least one processing device.

15. A non-transitory processor-readable storage medium having stored therein program code of one or more software programs, wherein the program code when executed by at least one processing given device causes the at least one processing given device to perform the following steps:
obtaining at least one processor-readable device behavior constraint that limits one or more behaviors of the at least one processing device;
monitoring at least one action performed by the at least one processing device;
determining if the at least one monitored action of the at least one processing device violates the at least one processor-readable device behavior constraint; and
initiating at least one automated action in response to a result of the determining.

16. The non-transitory processor-readable storage medium of claim 15, wherein the monitoring is performed in response to a successful authentication of a user of the at least one processing device.

17. The non-transitory processor-readable storage medium of claim 15, wherein the at least one processor-readable device behavior constraint comprises a constraint that limits one or more of: internal communications within the at least one processing device; external communications between the at least one processing device and at least one other device; one or more external devices that connect to the at least one processing device; and one or more communications of a designated type.

18. The non-transitory processor-readable storage medium of claim 15, wherein the at least one processor-readable device behavior constraint enforces one or more of: at least one policy of an organization; at least one designated device configuration; at least one expected device behavior and at least one processing device behavior rule.

19. The non-transitory processor-readable storage medium of claim 15, wherein the monitoring is performed by at least one software entity associated with an operating system of the at least one processing device, and wherein the monitoring comprises the at least one software entity associated with the operating system of the at least one processing device intercepting one or more requests to execute one or more device operations.

20. The non-transitory processor-readable storage medium of claim 15, wherein the at least one automated action comprises one or more of: generating an alert, denying one or more network connections of the at least one processing device; preventing a performance of one or more actions of the at least one processing device; preventing communications on one or more ports of the at least one processing device; and deactivating at least a portion of the at least one processing device.
